(19) United States
(12) Patent Application Publication
(10) Pub. No.: US 2005/0289597 A1
(43) Pub. Date: Dec. 29, 2005

(54) Processing controller, data processor, processing controlling method, program thereof and recording medium storing the program

(75) Inventors: Tetsuya Kawahara, Tokorozawa-shi (JP); Yukio Numakami, Tokorozawa-shi (JP); Naoaki Horiuchi, Tsurugashima-shi (JP); Motooki Sugihara, Tsurugashima-shi (JP); Masaki Kurihara, Tokorozawa-shi (JP)

Correspondence Address: ARMSTRONG, KRATZ, QUINTOS, HANSON & BROOKS, LLP, 1725 K STREET, NW, SUITE 1000, WASHINGTON, DC, 20006, US

(73) Assignee: PIONEER CORPORATION, Tokyo (JP)

(21) Appl. No.: 11/141,712

(22) Filed: Jun. 1, 2005

(30) Foreign Application Priority Data
Jun. 2, 2004 (JP) 2004-164934

(51) Int. Cl. G06F 3/00; H04N 5/445; G06F 13/00

(52) U.S. Cl. 725/52; 725/45; 725/53

(57) ABSTRACT

A CPU 290 of a recording/reproducing device 200 make a recording section 251 record contents reserved by a user for video recording in an HDD 270, and sets remaining time until the contents is automatically deleted. The CPU 290 determines, when a period T is over, whether access to the contents has been carried out or not, and adds additional time D to the remaining time when the CPU 290 determines that the access has been made, and subtracts the period T from the remaining time when the CPU 290 determines that the access has not been made. The CPU 290 executes the afore-mentioned processing once in each period T, and automatically deletes the contents from the HDD 270 when the CPU 290 recognizes that the remaining time is zero or below.

### BACKGROUND OF THE INVENTION

1. Field of the Invention

The present invention relates to a processing controller performing control to delete data stored in a storage unit, a data processor, a processing controlling method, a program thereof, and a recording medium storing the program.

2. Description of Related Art

There has been known a recording/reproducing device which records contents such as a TV program, reproduces the recorded contents, and automatically deletes the recorded contents (Refer to, for instance, Document 1: Japanese Patent Laid-Open Publication No. 2002-165162, and Document 2: Japanese Patent Laid-Open Publication No. 2002-305706).

In the recording/reproducing device described in Document 1, when data specifying a storage period for recorded data of a desired program is inputted by a user, the inputted storage period is set. Then the recording/reproducing device computes a period from the time when recording was finished until the current time, and when the computed period of time exceeds the specified storage period, the recorded data is automatically deleted.

In the recording/reproducing device disclosed in Document 2, when video data is recorded, priority level is set for the video data. When the video data is reproduced, the video data is set to priority level 3. When the video data is reproduced again, the video data is set to priority level 1 indicating that deletion of the video data is inhibited. When an empty space for recording data has been consumed in a hard disk while recording any video data, recording of the video data is overwritten on the video recording area for the video data with priority level 3.

In the recording/reproducing device as described in Document 1, however, it is necessary to set a period of time, namely a period of time until automatic deletion for each recorded data. Therefore, it is a problem, for instance, that an operation for inputting necessary data for setting the storage period of time is laborious and complicated. Further in the recording/reproducing device as described in Document 2, if video data is reproduced, when the video data is not set to priority level 1 inhibiting deletion thereof, the video data is set to priority level 3 allowing for overwriting of other video data. Therefore, to prevent favorite video data from being unexpectedly deleted automatically, it is necessary to set the video data to the priority level 1, and it is a problem, for instance, that the operation for setting is laborious and complicated.

### SUMMARY OF THE INVNETION

In view of the foregoing, it is an object of the present invention to provide a processing controller, a data processor, a processing controlling method capable of properly deleting data, a program thereof, and a recording medium storing the program therein.

The processing controller according to the present invention controls a data deleting unit, which is adapted for deleting data stored in a storage unit, to delete the data, and the processing controller includes a storage time acquiring unit for acquiring data storage time information concerning time at which the data was stored in the storage unit; a storage period acquiring unit for acquiring data storage period information concerning a period in which the data is stored in the storage unit; a processing state recognizing unit for recognizing, with a processing executing unit for executing processing of the data, the processing state of the data; a storage period changing unit for prolonging the period indicated by the data storage period information based on the processing state; and a deletion controlling unit for acquiring current time information concerning the current time and controlling the data deleting unit to delete, when recognizing that the elapsed time from the time indicated by the data storage time information exceeds the period indicates by the data storage period information, the data corresponding to the data storage time information.

The data processor according to the present invention includes the processing controller described above, a data video recording control unit for acquiring the data and storing the acquired data in the storage unit, the data deleting unit, the processing executing unit, and a timer for clocking the current time.

The processing controlling method controls, with a computing unit, a data deleting unit adapted for deleting data stored in a storage unit to delete the data, and in this method, the computing unit executes the steps of: acquiring data storage time information concerning the time at which the data was stored in the storage unit, acquiring data storage period information concerning a period in which the data is stored in the storage unit, recognizing, with a processing executing unit for executing processing of the data, the processing state of data, prolonging the period indicated by the data storage period information based on the processing state, acquiring current information concerning current time and controlling the data deleting unit to delete, when recognizing that the elapsed time from the time indicated by the data storage time information exceeds the period indicated by the data storage period information, the data corresponding to the data storage time information.

The processing controlling program according to the present invention makes the computing unit function as the processing controller according to the present invention as described above.

The processing controlling program according to the present invention makes a computing unit execute the processing controlling method according to the present invention described above.

The recording medium according to the present invention records therein the processing controlling program according to the present invention described above in a manner readable by a computing unit.

### BRIEF DESCRIPTION OF THE DRAWINGS

FIG. 1 is a block diagram showing general configuration of a contents recording/reproducing system according to an embodiment of the present invention;

FIG. 2 is a schematic view showing general configuration of video recording reservation list information in the embodiment;

FIG. 3 is a schematic view showing general configuration of contents management list information in the embodiment;

FIG. 4 is a schematic view showing general configuration of a CPU constituting the recording/reproducing device in the embodiment;

FIG. 5 is a flow chart showing a manual video recording reservation processing in the embodiment;

FIG. 6 is a flow chart illustrating an automatic video recording reservation processing in the embodiment;

FIG. 7 is a flow chart illustrating a reserved video recording processing in the embodiment;

FIG. 8 is a flow chart illustrating contents access processing in the embodiment;

FIG. 9 is a flow chart illustrating contents management processing in the embodiment;

FIG. 10 is a flow chart illustrating contents access processing according to another embodiment of the present invention; and

FIG. 11 is a flow chart showing contents management processing in another embodiment of the present invention.

### DETAILED DESCRIPTION OF THE PREFERRED EMBODIMENT(S)

An embodiment of the present invention is described below with reference to the related drawings. This embodiment is described below with reference to a recording/reproducing device having a data processor including the processing controller according to the present invention, but the present invention is not limited to this configuration, and any mechanism capable of deleting data stored in a storage unit may be employed in the present invention. In this embodiment, a processing for recording contents data which is data including audio data, video data, data broadcast data and the like of, for instance, a TV program, is described as a processing for video recording contents. The recording/reproducing device according to the present invention acquires manual video recording reservation information as specific data storage demand information set and inputted by a user in which start time, finish time for video recording, channel or the like are included. The processing for making reservation for video recording of particular contents specified by various items included in the manual video recording reservation demand information is described as manual video recording reservation processing in the following description. Further the processing for video recording executed based on manual video recording reservation is described as manually reserved video recording processing. Further the recording/reproducing device according to the present invention acquires automatic video recording reservation demand information in which a keyword as character information set and inputted by a user. In this embodiment, by referring to undermentioned EPG (Electric Program Guide) data which is data-related information, the processing for reserving video recording of contents relating to a keyword included in the automatic video recording reservation demand information is described as automatic video recording reservation processing. In addition, the video recording processing carried out based on automatic video recording reservation is described as automatically reserved video recording processing.

[Configuration of the Contents Recording/Reproducing System]

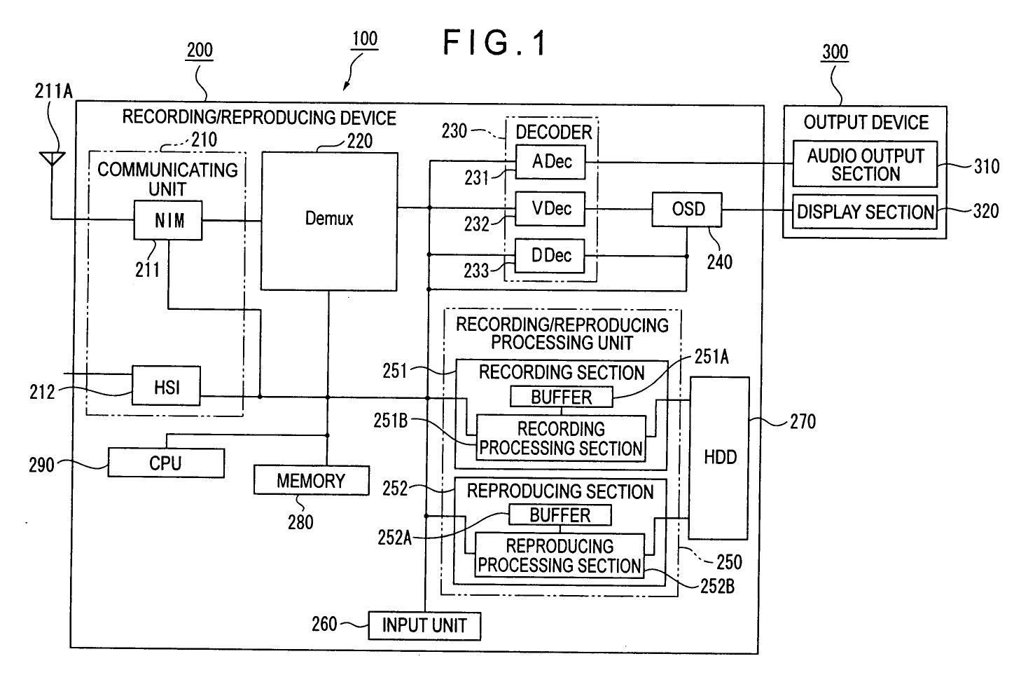

In FIG. 1, the reference numeral 100 indicates a contents recording/reproducing system (described as a recording/reproducing system hereinafter), which records contents data of such as contents of a TV program or reproduces the recorded contents. The recording/reproducing system 100 comprises a recording/reproducing device 200, and an output device 300.

The output device 300 is, for instance, a personal computer, a television, a mobile telephone, or a PDA (Personal Digital Assistant). This output device 300 receives contents inputted from the recording/reproducing device 200 and outputs the recorded contents. The output device 300 may have any configuration for outputting audio data as voices and sounds, or for displaying video data, data for broadcasting, EPG data, synthetic data, or the like on a screen, and also may have both an audio output section 310 for outputting voices and sounds and a display section 320 for providing screen displays as shown in FIG. 1.

The recording/reproducing device 200 acquires and records contents data including audio data, video data, and data for broadcasting distributed as TS (Transport Stream), and outputs the recorded contents data with the output device 300. Further the recording/reproducing device 200 reproduces the recorded contents data according to necessity and makes the output device 300 outputs the recorded contents data. Further the recording/reproducing device 200 comprises a communication unit 210, a demultiplexer (Demux) 220, a decoder 230, an on-screen display (OSD) 240, a recording/reproducing processing unit 250, an input unit 260, a hard disk drive (HDD) 270 as a storage unit, a memory 280, and a CPU (Central Processing Unit) 290 as a computing unit.

The communicating unit 210 acquires contents data inputted from the outside, or outputs the contents data to the outside according to necessity. The communicating unit 210 may have the configuration for receiving broadcast wave such as, for instance, surface wave digital broadcasting or satellite digital broadcasting, or for acquiring TS transmitted as digital signals or partial TS described hereinafter and outputs the acquired TS to inside or outside of the recording/reproducing device 200, and also may have the configuration including both a network interface module (NIM) 211 including an antenna 211A for acquiring broadcast wave and a high speed interface (HSI) 212 for acquiring and processing TS or partial TS according to necessity.

The Demux 220 acquires TS, separates TS packets from this TS, and outputs the separated TS packets according to necessity. Connected to this Demux 220 are the decoder 230, recording/reproducing processing unit 250, and CPU 290. The Demux 220 acquires TS from the NIM 211, HSI 212 under control of the CPU 290 according to necessity. Further, the Demux 220 acquires TS packets for various types data corresponding to the contents selected from the TS. More specifically, the Demux 220 acquires TS packets each including audio data (described as audio packets hereinafter), TS packets including video data (described as video packets hereinafter), and TS packets including data broadcast data or EPG data (described as data packets hereinafter). In addition, the Demux 220 outputs the audio packets, video packets, and data packets acquired as described above to the decoder 230.

The EPG data is configured of information concerning contents such as a TV program including in each TS which the NIM 211 can acquire or data described in a text format such as BML (broadcast Markup Language) or XML (eXtensible Markup Language). More specifically, the EPG data has a table structure in which descriptions concerning a program such as a program title and contents of the program, broadcast start time, duration of the program, a channel number, a category, a series name and the like compiled as a group of data.

Further the Demux 220 acquires TS packets corresponding to the selected contents from the acquired TS under control of the CPU 290, and reorganizes the TS packets into a TS based on a series of data strings, namely into a partial TS. Then the Demux 220 outputs the partial TS to the recording/reproducing processing unit 250. Further the Demux 220 acquires the partial TS from the HSI 212 or the recording/reproducing processing unit 250 under control of the CPU 290 according to necessity. Then the Demux 220 divides the partial TS into an audio packet, a video packet, and a data packet, and outputs the packets to the decoder 230.

The decoder 230 is connected to an OSD 240, a CPU 290, and to the output device 300. This decoder 230 demodulates the packets acquired from the Demux 220, and outputs the packets to the OSD 240 or to the output device 300. The decoder 230 may have the configuration for demodulating audio data, for demodulating video data, for demodulating data broadcast data or EPG data, or the configuration based on a combination of those described above, and further may have the configuration including both an audio decoder (ADec) 231, a video decoder (VDec) 232 and data decoder (DDec) 233 each for demodulating data as shown in FIG. 1.

The OSD 240 is connected, for instance, to the CPU 290, and a display section 320 of the output device 300. This OSD 240 acquires video data from the VDec 232, data broadcast data or EPG data from DDec 233 according to necessity, and generates synthesized data for selectively displaying, for instance, video, caption, program table and the like in the superimposed state. This synthesized data is transmitted to the display section 320 of the output device 300, and is outputted according to necessity. Also the configuration not including the OSD 240 is allowable.

The recording/reproducing processing unit 250 is connected to the HDD 270, CPU 290, and other related sections. This recording/reproducing processing unit 250 acquires partial TS from the Demux 220 and stores the acquired partial TS in the HDD 270. Further the recording/reproducing processing unit 250 acquires the partial TS from the Demux 220 according to necessity, and outputs the partial TS to the HSI 212 or the Demux 220. This recording/reproducing processing unit 250 includes a recording section 251 and a reproducing section 252.

The recording section 251 records the partial TS from the Demux 220 in the HHD 270. This recording section 251 includes a buffer 251A, and a recording processing section 251B. The buffer 251A temporally records therein the partial TS from the Demux 220. The recording processing section 251B acquires, under control of the CPU 290, the partial TS from the Demux 220 and stores the partial TS in the buffer 251A in the readable state. Then the recording processing section 251B reads out the partial TS stored in the buffer 251A according to necessity and outputs the partial TS to the HDD 270.

The reproducing section 252 outputs the partial TS stored in the HDD 270 to the HSI 212 or to the Demux 220 according to necessity. This reproducing section 252 includes, for instance, a buffer 252A, and a reproducing processing section 252B. The buffer 252A temporally stores therein the partial TS from the HDD 270. The reproducing processing section 252B acquires the partial TS from the HDD 270 under control of the CPU 290, and stores the partial TS in the buffer 252A in the readable state according to necessity. Then the reproducing processing section 252B reads out the partial TS stored in the buffer 252A according to necessity and outputs the partial TS to the HSI 212 or to the Demux 220.

The input unit 260 is connected to the CPU 290 and other related components. This input unit 260 has various types of operation buttons or operation knobs and the like (not shown) and provided, for instance, on a front panel of a casing (not shown) in the input-operable state. These operation buttons or operation knobs are used to input, for instance, necessary data for setting operational contents of the recording/reproducing device 200. More specifically, the buttons and knobs are used, for instance, to input necessary data required for recording or reproduction of contents, or for specifying TS to be received by the NIM 212 (translator's comment: correctly, 211). The input unit 260 transmits various information as operation-related signals to the CPU 290 according to the operations for setting. The input unit 260 may have a remotely-controlled light receiving section for receiving various types of information transmitted, for instance, from a remote controller (not shown) via infrared ray and transmitting the information as operation-related signals to the CPU 290.

The HDD 270 is connected to the CPU 290 and other related components. This HDD 270 is controlled by an ATA (AT Attachment) interface. The configuration in which the HDD 270 is controlled by the ATA interface is described as am example below, but the HDD 270 may be controlled, for instance, by an IDE (Integrated Drive Electronics) interface or a SCSI (Small Computer System Interface). The HDD 270 reads out partial TS for contents inputted from the recording section 251, namely contents data and stores the contents data in the readable state. Further the HDD 270 stores therein, for instance, the latest EPG data acquired in the NIM 211 in the readable state according to necessity. Also the configuration is allowable in which a drive or a driver, or a combination thereof is used in place of the HDD 270 to store various types of information in the readable state in various types of recording media including, a detachable memory such as an optical disk like a DVD (Digital Versatile Disk), a photo-magnetic disk, and a memory card, or a fixed memory.

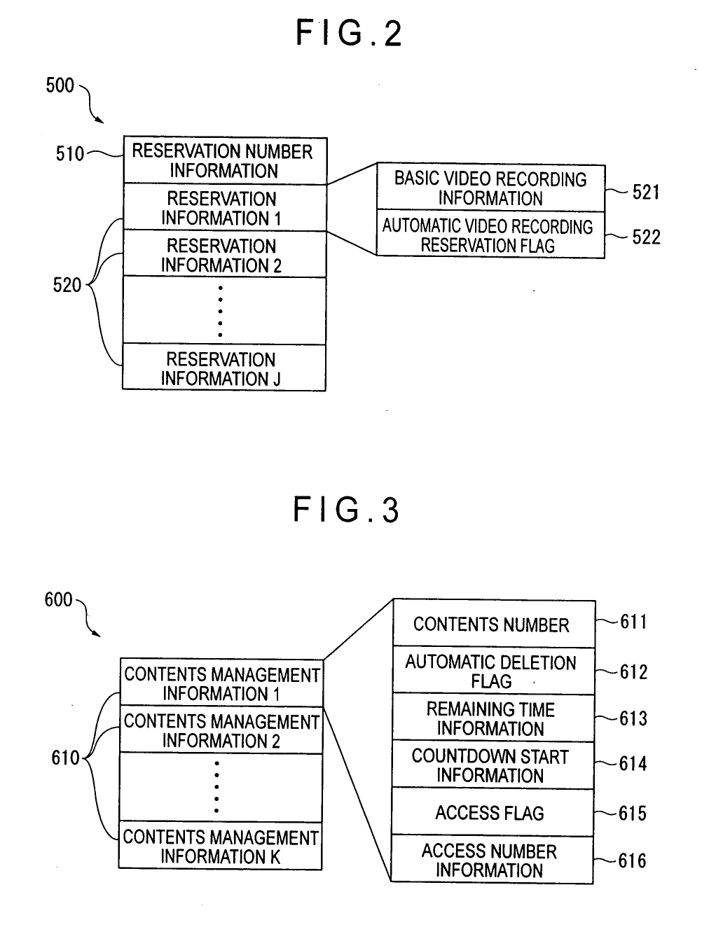

The memory 280 reads and stores therein various types of data required for acquiring desired contents data from TS outputted from the NIM 211 and recording the acquired contents data, or for reproduced the recorded contents data. Further the memory 280 stores video recording reservation list information 500 as shown in FIG. 2, contents management list information 600 shown in FIG. 3 and the like according to necessity and stores the information in the readable state.

The video recording reservation list information 500 is information concerning a list of programs reserved to be recorded manually or automatically. This video recording reservation list information 500 includes at least one reservation number information 510 and at least one reservation information 520 correlated to each other and compiled into one data structure.

The reservation number information 510 indicates a total number of reservation information 520. This reservation number information 510 is increased by 1 each a manual video recording reservation or an automatic video recording reservation is added by the CPU 290, and is decreased by 1 when video recording based on manual video recording reservation or automatic video recording reservation is finished.

The reservation information 520 indicates a manual video recording reservation or an automatic video recording reservation. This reservation information 520 is incorporated in the video recording reservation list information 500 when a manual video recording reservation or an automatic video recording reservation is set by the CPU 290, and is deleted from the video recording reservation list information 500 when video recording based on any manual video recording reservation or automatic recording reservation is finished. The reservation information 520 includes basic video recording information 521 and an automatic video recording reservation flag 522 correlated to each other and compiled into a data structure.

The basic video recording information 521 includes various information necessary for a manual video recording reservation processing or an automatic video recording reservation processing. Specifically, the basic video recording information 521 includes a start time of video recording, a finish time of video recording and a channel number correlated to each other and compiled into one data structure. The basic video recording information 521 is properly modified by the CPU 290.

The automatic video recording reservation flag 522 is a flag indicating whether the video recording processing based on the basic video recording information 521 is an automatic video recording reservation processing or not. Specifically, when the automatic video recording reservation flag 522 is “0”, it indicates that the video recording processing is not an automatic video recording reservation processing but a manual video recording reservation processing; and when the flag is “1”, it indicates that the video recording processing is an automatic video recording reservation processing.

The contents management list information 600 is information concerning a list of information corresponding to contents recorded on the HDD 270. The contents management list information 600 includes at least one contents management information 610 correlated and compiled into one data structure.

The contents management information 610 is incorporated in the contents management list information 600 when contents is stored on the HDD 270 by the CPU 290, and is deleted from the contents management list information 600 when the contents is deleted from the HDD 270. The contents management information 610 includes a contents number 611, an automatic deletion flag 612 as data attribute information, remaining time information 613 also functioning as data storage period information, countdown start information 614, an access flag 615 and access number information 616 correlated to each other and compiled into one data structure. The contents management information 610 may be configured to include a contents number 611 and an automatic deletion flag 612 only, correlated to each other and compiled into one data structure.

The contents number 611 is information concerning a unique number given to the contents stored on the HDD 270. Information concerning a unique name given to the contents, for instance, may be used as a substitute to the contents number 611.

The automatic deletion flag 612 indicates whether the content identified by the contents number 611 is to be subjected to automatic deletion by the CPU 290 or not. Specifically, when the automatic deletion flag 612 is “0”, it indicates that the contents is not subjected to automatic deletion; and when the flag is “1”, it indicates that the contents is subjected to automatic deletion. The automatic deletion flag 612 is updated by the CPU 290 according to necessity.

The countdown start information 614 is information concerning a countdown start time at which counting-down of a prespecified period T is started. The countdown start information 614 is information indicating a video recording finish time as data storage time information concerning the time of storage of the contents specified by the contents number 611, or information of alteration time concerning the time at which the remaining time information 614 (translator's comment: correctly, 613) is altered by the CPU 290, as the case may be. The countdown start information 614 is updated as appropriate by the CPU 290.

The access flag 615 is flag information indicating whether reproduction processing or edit processing has been performed at least once on the contents specified by the contents number 611 or not; namely, it is flag information indicating whether the contents is accessed at least once or not. Specifically, when the access flag 615 is “0”, it indicates that the contents is not accessed at all; and when the access flag 615 is “1”, it indicates that the contents is accessed at least once. The access flag 615 is updated as appropriate by the CPU 290.

The access number information 616 is information concerning the number of times of the access to the contents identified by the contents number 611. The access number information 616 is updated as appropriate by the CPU 290.

The memory 280 stores in a computer-readable state various programs loaded on an OS (Operating System) controlling the recording/reproducing device 200 as a whole. Use of CMOS (complementary metal-oxide semiconductor) memory chips is preferred for the memory 280, allowing memory contents to be retained even when the power is shut down abruptly, as in the case of power failure. The memory 280 may be configured to include a drive such as a hard disk drive, a DVD drive or an optical disk drive that stores data on recording media in a computer-readable state, and a driver thereof.

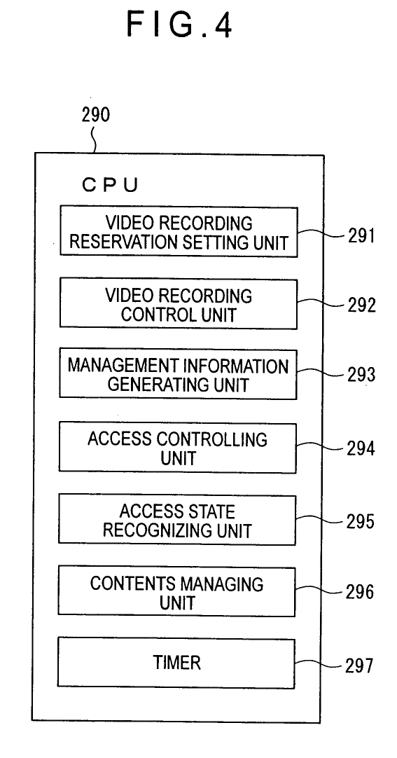

As shown in FIG. 4, the CPU 290 includes a video recording reservation setting unit 291, also functioning as a data-related information acquiring unit, as a character information acquiring unit, and as a storage request information acquiring unit; a video recording control unit 292 as a data video recording control unit; a management information generating unit 293, also functioning as a storage time acquiring unit and as a storage period acquiring unit; an access controlling unit 294 as a processing performing unit; an access state recognizing unit 295 as a processing state recognizing unit; a contents management unit 296, also functioning as a data deleting unit, as a storage period changing unit and as a deletion controlling unit; and a timer 297. The processing controller according to the present invention includes the management information generating unit 293, the access state recognizing unit 295 and the contents management unit 296. The data processor according to the present invention includes the video recording reservation setting unit 291, the video recording control unit 292, the management information generating unit 293, the access controlling unit 294, the access state recognizing unit 295, the contents management unit 296 and the timer 297. The data processor according to the present invention may also be configured not to include the video recording reservation setting unit 291.

The timer 297 clock s the current time based on a base pulse such as generated by an internal clock. The timer 297 also outputs current time information concerning the current time as measured, as required.

The video recording reservation setting unit 291 acquires automatic video recording reservation request information sent as operation-related signals from the input unit 260 as required. The video recording reservation setting unit 291 then performs automatic video recording reservation processing based on the automatic video recording reservation request information. Specifically, the video recording reservation setting unit 291 controls the DDec 233 and stores EPG data coded on the TS acquired through NIM 211 to the HDD 270. Upon acquiring the automatic video recording reservation request information, the video recording reservation setting unit 291 recognizes a keyword, for instance, coded in the automatic video recording reservation request information, and acquires the EPG data stored on the HDD 270. The video recording reservation setting unit 291 then searches the EPG data for contents with a program name, a program description, a genre or a series name that matches or relates to the recognized keyword. Upon recognizing that contents with, for instance, the program name related to the keyword is found, the video recording reservation setting unit 291 generates basic video recording information 521 including information concerning a video recording start time, a video recording finish time and a channel number of the contents based on the EPG data. The video recording reservation setting unit 291 also generates a flag information of “1”, which indicates that the video recording processing based on the basic video recording information 521 is an automatically reserved video recording processing. The video recording reservation setting unit 291 then generates an automatic video recording reservation flag 522 including the flag information above. The video recording reservation setting unit 291 generates reservation information 520 as appropriate, including the basic video recording information 521 and the automatic video recording reservation flag 522, and incorporates the reservation information 520 in the video recording reservation list information 500. When the video recording reservation setting unit 291 recognizes that a plurality of contents is found related, for instance, to the keyword, the video recording reservation setting unit 291 generates a plurality of sets of reservation information 520 each corresponding to a set of contents found, and incorporates the generated sets of the reservation information 520 in the video recording reservation list information 500. The video recording reservation setting unit 291 further performs a process of adding the number of sets of the reservation information 520 added in the video recording reservation list information 500 to the reservation number information 510. In the above example, a configuration is described in which EPG data is used in generating the reservation information 520 corresponding to the automatic video recording reservation, but other configurations are also possible in which other data are used.

The video recording reservation setting unit 291 also controls the DDec 233 and stores the latest EPG data on the HDD 270 as appropriate. The video recording reservation setting unit 291 then refers the EPG data, and when, for instance, a broadcast of a sporting event is extended and recognizes that the start time and the finish time of the contents reserved for automatic video recording are altered, the video recording reservation setting unit 291 alters the basic video recording information 521 in the reservation information 520 according to the nature of the alteration as appropriate.

Further, the video recording reservation setting unit 291 acquires manual video recording reservation request information sent as operation-related signals from the input unit 260 as required. The video recording reservation setting unit 291 then performs manual video recording reservation processing based on the manual video recording reservation request information. Specifically, upon acquiring the manual video recording reservation request information, the video recording reservation setting unit 291 recognizes information concerning the video recording start time, the video recording finish time and the channel number coded in the manual video recording reservation request information, and generates basic video recording information 521 including the various information. The video recording reservation setting unit 291 also generates a flag information of “0”, indicating that video recording processing based on the basic video recording information 521 is a manually reserved video recording processing. The video recording reservation setting unit 291 then generates an automatic video recording reservation flag 522 including the flag information above. The video recording reservation setting unit 291 generates reservation information 520 as appropriate, including the basic video recording information 521 and the automatic video recording reservation flag 522, and incorporates the reservation information 520 in the video recording reservation list information 500. The video recording reservation setting unit 291 further increments the reservation number information 510 by 1.

The video recording control unit 292 controls operation of the NIM 211, the Demux 220 and the recording section 251 of the recording/reproducing processing unit 250, and processes receiving contents data of desired contents and storing the data on the HDD 270 in a readable state as required. Specifically, the video recording control unit 292 performs storage operation of contents data being received and reproduced according to operation-related signals based on input operations at the input unit 260, or performs operation for receiving and storing contents data based on the reservation information 520 in the video recording reservation list information 500 with the video recording start time in the reservation information 520 identical to the current time as measured by the timer 297. When the process of storing the contents data, namely, the video recording process, is performed, the video recording control unit 292 assigns a unique number to the contents data.

The management information generating unit 293 generates contents management information 610 as required and incorporates the contents management information 610 to the contents management list information 600. Specifically, the management information generating unit 293, upon recognition that a video recording process is performed by the video recording control unit 292 based on the reservation information 520, identifies the unique number assigned to the contents. The management information generating unit 293 then generates the contents number 611 including the unique number. Further, the management information generating unit 293 identifies the setting of the automatic video recording reservation flag 522 of the reservation information 520 related to the contents.

Further, upon recognition that the reserved video recording of the contents is a manually reserved video recording based on the setting of the automatic video recording reservation flag 522, the management information generating unit 293 generates an automatic deletion flag 612 including flag information of “0” indicating as such. In the configuration described above by way of example only, the flag information of “0” is set to the automatic deletion flag 612 upon recognition of the manually reserved video recording, but another configuration is also possible in which, for instance, contents stored with manually reserved video recording are subject to automatic deletion, and flag information of “1” is included in the automatic deletion flag 612. Further, the video recording control unit 292 (translator's comment: correctly, management information generating unit 293) generates contents management information 610 including the contents number 611 and the automatic deletion flag 612, and incorporates the contents management information 610 to the contents management list information 600. Upon adding the contents management information 610 to the contents management list information 600, the management information generating unit 293 also performs a process of updating the video recording reservation list information 500. Specifically, the management information generating unit 293 performs a process of deleting the reservation information 520 related to the contents from the video recording reservation list information 500 and decrementing the reservation number information 510 by 1

Also, upon recognition that the reserved video recording of the contents is automatically reserved video recording based on the setting of the automatic video recording reservation flag 522, the management information generating unit 293 generates an automatic deletion flag 612 including flag information of “1” indicating as such. In the configuration presented above by way of example only, the flag information of “1” is set to the automatic deletion flag 612 upon recognition of the automatically reserved video recording, but another configuration is also possible in which, for instance, contents stored with the automatically reserved video recording are not subject to automatic deletion, and flag information of “0” is included in the automatic deletion flag 612. Further, the management information generating unit 293 sets a remaining time until automatic deletion to, for instance, a prespecified time Z, and generates and acquires remaining time information 613 concerning the remaining time. Further, the management information generating unit 293 sets a countdown start time to the video recording finish time and generates countdown start information 614 concerning the countdown start time. Further, the management information generating unit 293 generates flag information of “0” indicating that the content is not accessed at all. The management information generating unit 293 then generates an access flag 615 including the flag information. The management information generating unit 293 also sets an access number of the contents to 0, and generates access number information 616 including the access number. The management information generating unit 293 then generates contents management information 610 including the contents number 611, the automatic deletion flag 612, the remaining time information 613, the countdown start information 614, the access flag 615 and the access number information 616 as required, and incorporates the contents management information 610 to the contents management list information 600. Further, the management information generating unit 293 performs operation for updating the video recording reservation list information 500.

Further, the management information generating unit 293, upon recognition that a video recording process is performed based on the video recording start information and the video recording end information with the video recording control unit 292, performs processes similar to as in the case of the manually reserved video recording. Namely, the management information generating unit 293 generates contents management information 610 including the contents number 611 and the automatic deletion flag 612 as required and incorporates the contents management information 610 to the contents management list information 600.

The access controlling unit 294 performs a reproduction process of the contents stored on the HDD 270 based on various information sent from the input unit 260 as operation-related signals. Specifically, upon acquiring reproduction request information sent from the input unit 260 as operation-related signals, the access controlling unit 294 recognizes a request for reproducing contents based on the reproduction request information. Further, upon acquiring contents specifying information sent from the input unit 260, the access controlling unit 294 identifies a number specifying contents based on the contents specifying information. The access controlling unit 294 then controls operation of the reproducing section 252, the Demux 220, the decoder 230 and the OSD 240, and performs a process for outputting the contents data to the output device 300 as appropriate.

Also, the access controlling unit 294 acquires fast-forward information or rewind information sent from the input unit 260 as operation-related signals as required. The access controlling unit 294 then performs fast-forward or rewind processes of the contents being reproduced based on the fast-forward information or the rewind information.

Further, the access controlling unit 294, upon acquiring edit request information sent from the input unit 260 as operation-related signals, recognizes a request for editing the contents based on the edit request information. Further, upon acquiring contents specifying information sent from the input unit 260, the access controlling unit 294 identifies a number specifying contents based on the contents specifying information. The access controlling unit 294 then controls operation of the reproducing section 252, the Demux 220, the decoder 230, the OSD 240 and the recording section 251 as appropriate, and performs a process of editing the contents data requested to be edited as appropriate.

The access controlling unit 294 also acquires access termination information sent from the input unit 260 as operation-related signals as required. The access controlling unit 294 then controls the Demux 220, the decoder 230, the OSD 240 and the recording/reproducing processing unit 250 as appropriate and performs a process of terminating the reproduction process or the edit process as appropriate.

The access state recognizing unit 295 recognizes an access state to contents stored on the HDD 270 as required and alters the access flag 615 and the access number information 616 in the contents management information 610 as appropriate. Specifically, the access state recognizing unit 295, upon recognition of a start of reproduction or edit processes, namely, a start of an access process to the contents, under control of the access controlling unit 294, acquires a current time from the timer 297. The access state recognizing unit 295 thus recognizes the start time of the access process. Upon recognition of an end of the access process to the contents, the access state recognizing unit 295 acquires a current time from the timer 297, and recognizes an finish time of the access process. Further, the access state recognizing unit 295 recognizes an access duration to the contents based on the start time and finish time as recognized.

When the access state recognizing unit 295 recognizes that the access duration is equal to or longer than a prespecified changing reference duration R, the access state recognizing unit 295 identifies a number specifying the contents having been accessed based on contents specifying information acquired with the access controlling unit 294. The access state recognizing unit 295 further searches for a contents number 611 carrying a number matching to the specifying number from the contents management list information 600, and identifies contents management information 610 including the searched contents number 611. The access state recognizing unit 295 then increments the access number information 616 of the contents management information 610 by 1. Further, when the access state recognizing unit 295 recognizes that the access flag 615 of the access number information 616 is set to “0”, the access state recognizing unit 295 sets the access flag 615 to “1”.

The contents management unit 296 automatically deletes contents from the HDD 270 as appropriate, based on an elapsed time from storage of the contents on the HDD 270 and an access state. Specifically, the contents management unit 296 searches for contents management information 610 including the automatic deletion flag 612 set to “1” from the contents management list information 600, namely contents management information 610 corresponding to contents set to be subject to automatic deletion. The contents management unit 296 then recognizes a countdown start time of the contents corresponding to each of the contents management information 610 based on the countdown start information 614 of the searched contents management information 610. The contents management unit 296 also acquires current time information from the timer 297 as appropriate and recognizes the current time. Further, when the contents management unit 296 recognizes that the calculated period from the countdown start time of any of the contents is equal to or longer than a prespecified period T, the contents management unit 296 identifies the contents management information 610 corresponding to the contents.

Further, when the contents management unit 296 recognizes that the access flag 615 of the contents management information 610 is set to “0”, the contents management unit 296 recognizes that the contents is not accessed at all during the period T from the countdown start time. Further, when the contents management unit 296 recognizes that the remaining period as indicated by the remaining time information 613 of the contents management information 610 minus the period T is 0 or less, the contents management unit 296 automatically deletes the contents corresponding to the contents management information 610 from the HDD 270 and removes the contents management information 610 from the contents management list information 600. When, however, contents management unit 296 recognizes that the remaining time after subtracting the period T is 0 or over, the contents management unit 296 sets the current time to the countdown start time indicated by the countdown start information 614 of the contents management information 610.

Further, when the contents management unit 296 recognizes that the access flag 615 of the contents management information 610 is set to “1”, the contents management unit 296 recognizes that the contents is accessed at least once during the period T from the countdown start time of the contents. The contents management unit 296 also recognizes the access number based on the access number information 616 of the contents management information 610. And when the contents management unit 296 recognizes that the access number is equal to or larger than a prespecified cutoff count L (L is a natural number), the contents management unit 296 sets “0” to the automatic deletion flag 612 of the contents management information 610. When, on the other hand, the contents management unit 296 recognizes that the access number is less than the prespecified cutoff count L, the contents management unit 296 sets to the remaining time information 613 the remaining time as indicated by the remaining time information 613 plus an additional period G as a prespecified period, as a new remaining time. The contents management unit 296 also sets the access flag 615 of the contents management information 610 to “0” and the access number of the access number information 616 thereof to 0. Further, the contents management unit 296 sets the countdown start time indicated by the countdown start information 614 to the current time.

[Function of the Contents Recording/Reproducing System]

The function of the contents recording/reproducing system 100 is next described hereinafter with reference to drawings.

(Manual Video Recording Reservation Processing)

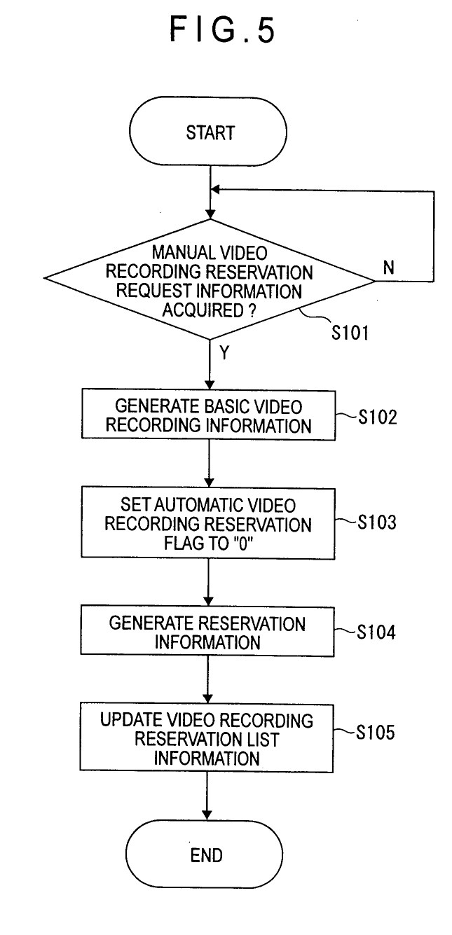

Manual video recording reservation processing as a function of the contents recording/reproducing system 100 is first described with reference to FIG. 5.

A user first sets and inputs manual video recording reservation request information concerning various information such as a video recording start time, a video recording finish time and a channel number necessary for a manual video recording reservation of desired contents with input operations on the input unit 260. The recording/reproducing device 200, upon acquiring the manual video recording reservation request information with the video recording reservation setting unit 291 of the CPU 290 (Step S101) as shown in FIG. 5, recognizes various information coded in the manual video recording reservation request information such as the video recording start time, the video recording finish time and the channel number. The video recording reservation setting unit 291 then generates basic video recording information 521 including the various information (Step S102). The video recording reservation setting unit 291 further generates an automatic video recording reservation flag 522 including flag information set to “0” (Step S103). Thereafter, the video recording reservation setting unit 291 generates reservation information 520 including the basic video recording information 521 and the automatic video recording reservation flag 522 (Step S104). The video recording reservation setting unit 291 then updates the video recording reservation list information 500 (Step S105) and terminates the manual video recording reservation processing. Specifically, the video recording reservation setting unit 291 incorporates the generated reservation information 520 in the video recording reservation list information 500. Then the video recording reservation setting unit 291 increments the reservation number information 510 by 1 and terminates the manual video recording reservation processing.

(Automatic Video Recording Reservation Processing)

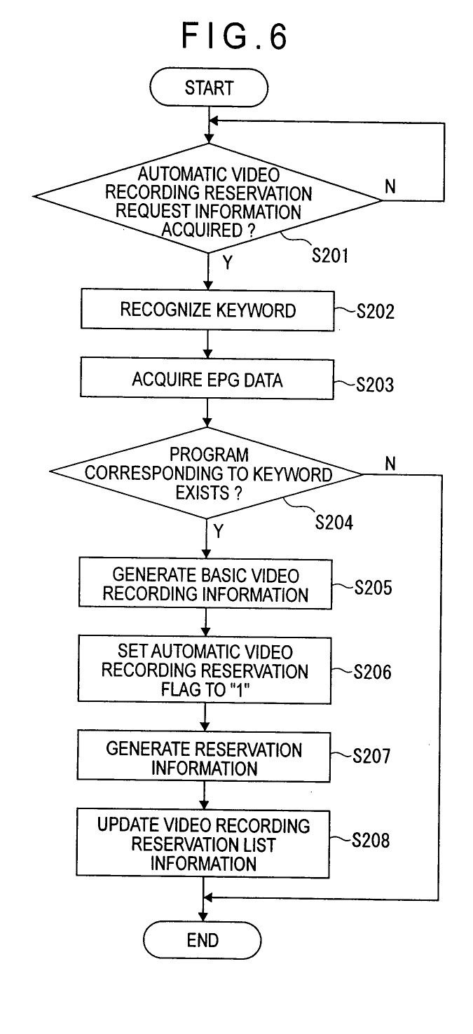

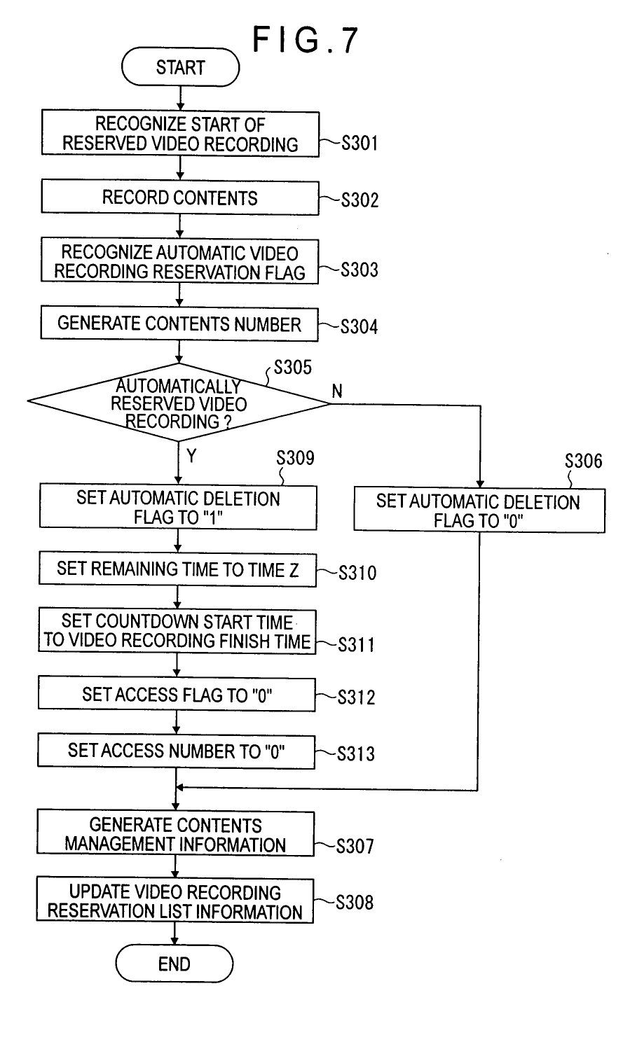

Automatic video recording reservation processing as a function of the contents recording/reproducing system 100 is next described with reference to FIG. 6.

A user first sets and inputs automatic video recording reservation request information concerning, for instance, a keyword related to a name or details of desired contents with input operations on the input unit 260. The recording/reproducing device 200, upon acquiring the automatic video recording reservation request information with the video recording reservation setting unit 291 of the CPU 290 (Step S201) as shown in FIG. 6, recognizes, for instance, the keyword coded in the automatic video recording reservation request (Step S202). The recording/reproducing device 200 also acquires DPG data that the recording/reproducing device 200 has acquired and stored on the HDD 270 with the NIM211 before hand (Step S203). Then the video recording reservation setting unit 291 judges whether a program corresponding to the keyword set by the user exists or not (Step S204). Specifically, the video recording reservation setting unit 291 judges whether contents with a program name, a program description, a genre or a series name matching or relating to the keyword are found from the EPG data.

In the Step S204, when the video recording reservation setting unit 291 judges that there exist no programs corresponding to the keyword, the video recording reservation setting unit 291 terminates the automatic video recording reservation processing. When, on the other hand, the video recording reservation setting unit 291 judges that there exist a program corresponding to the keyword, the video recording reservation setting unit 291 recognizes various information such as a broadcasting start time, a program duration and a channel number of the contents. The video recording reservation setting unit 291 then generates basic video recording information 521 including a video recording start time, a video recording finish time and a channel number (Step S205). The video recording reservation setting unit 291 further generates an automatic video recording reservation flag 522 including flag information set to “1” (step S206). Thereafter, the video recording reservation setting unit 291 generates reservation information 520 including the basic video recording information 521 and the automatic video recording reservation flag 522 (Step S207), updates the video recording reservation list information 500 (Step S208) and terminates the automatic video recording reservation processing. When the video recording reservation setting unit 291 judges in the Step S207 that there are a plurality of sets of contents corresponding to the keyword, the video recording reservation setting unit 291 generates a plurality of sets of reservation information 520 each corresponding to each set of the contents in the Step 207.

(Reserved Video Recording Processing)

Reserved video recording processing based on the manual video recording reservation or the automatic video recording reservation as a function of the contents recording/reproducing system 100 is next described with reference to FIG. 7.

The recording/reproducing device 200 recognizes with the video recording control unit 292 of the CPU 290 a current time based on current time information from the timer 297, and recognizes the video recording start time based on the basic video recording information 521 of each of the reservation information 520. Thereafter, when the video recording control unit 292 recognizes that the current time is the video recording start time of the reserved video recording corresponding to any of the reservation information 520 (Step S301), the video recording control unit 292 identifies the channel number of the contents to be video-recorded based on the basic video recording information 521. The video recording control unit 292 then controls the NIM 211, the Demux 220 and the recording section 251 as appropriate and stores the contents on the HDD 270 (Step S302). Thereafter, upon recognition that the current time is the video recording finish time based on the basic video recording information 521, the video recording control unit 292 terminates recording of the contents and assigns a unique number to the contents.

The CPU 290 recognizes, with the management information generating unit 293, the setting of the automatic video recording reservation flag 522 of the reservation information 520 corresponding to the reserved video recording of the contents (Step S303). Thereafter the management information generating unit 293 identifies the number assigned to the contents stored on the HDD 270, and generates a contents number 611 related to the assigned number (Step S304). The management information generating unit 293 then judges whether the reserved video recording of the contents is an automatically reserved video recording or not, based on the setting of the automatic video recording reservation flag 522 recognized in the Step S303 (Step S305).

When the management information generating unit 293 judges that the reserved video recording is a manually reserved video recording and not an automatically reserved video recording, the management information generating unit 293 generates an automatic deletion flag 612 including flag information set to “0” (Step S306). Another configuration is also possible in which, for instance, contents stored with manually reserved video recording are subject to automatic deletion, and the management information generating unit 293 generates an automatic deletion flag 612 including flag information set to “1”. The management information generating unit 293 then generates contents management information 610 including the contents number 611 and the automatic deletion flag 612 (Step S307) and incorporates the contents management information 610 to the contents management list information 600. Thereafter the management information generating unit 293 updates the video recording reservation list information 500 (Step S308) and terminates the video recording reservation processing.

When, on the other hand, the management information generating unit 293 judges in the Step S305 that the reserved video recording is an automatically reserved video recording, the management information generating unit 293 generates an automatic deletion flag 612 including flag information set to “1” (Step S309). Another configuration is also possible in which, for instance, contents stored with automatically reserved video recording are not subject to automatic deletion, and the management information generating unit 293 generates an automatic deletion flag 612 including flag information set to “0”. Further, the management information generating unit 293 sets the remaining time until automatic deletion to, for instance, the time Z, and generates remaining time information 613 concerning the remaining time (Step S310). Further, the management information generating unit 293 sets a countdown start time to the video recording finish time and generates countdown start information 614 concerning the countdown start time (Step S311). The management information generating unit 293 then generates an access flag 615 including flag information set to “0” (Step S312). The management information generating unit 293 also sets an access number to 0, and generates access number information 616 including the access number (Step S313). The management information generating unit 293 then performs processes described in the Step 308, namely processes of generating the contents management information 610. Here, the management information generating unit 293 generates contents management information 610 including the contents number 611, the automatic deletion flag 612, the remaining time information 613, the countdown start information 614, the access flag 615 and the access number information 616, and incorporates the contents management information 610 to the contents management list information 600.

(Contents Access Processing)

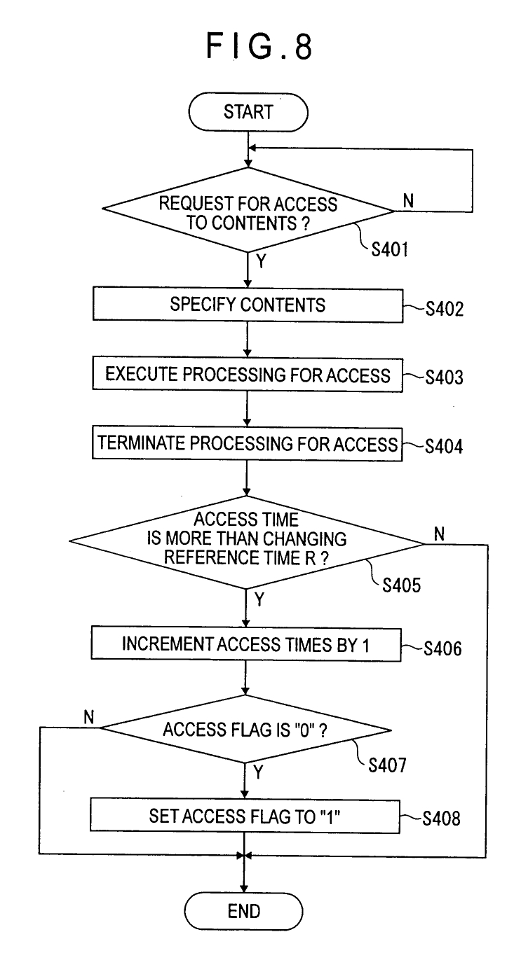

Contents access processing as a function of the contents recording/reproducing system 100 is next described with reference to FIG. 8. Here contents reproduction processing is used by way of example only of the contents access processing.

A user first sets and inputs reproduction request information requesting reproduction of any desired contents with input operations on the input unit 260. The recording/reproducing device 200, upon acquiring the reproduction request information with the access controlling unit 294 of the CPU 290, recognizes that reproduction of certain contents is requested (Step S401). The user thereafter sets and inputs contents specifying information specifying contents for reproduction with input operations on the input unit 260 as appropriate. The access controlling unit 294 of the recording/reproducing device 200, upon acquiring the contents specifying information, specifies contents for reproduction based on, for instance, a number specifying contents coded in the contents specifying information (Step S402). Thereafter, the access controlling unit 294 performs access processing to the contents (Step S403). Here, the access controlling unit 294 controls the reproducing section 252 for acquiring contents data of the contents with the assigned number matching the number coded in the contents specifying information from the HDD 270. Thereafter the access controlling unit 294 controls the Demux 220, the decoder 230 and the OSD 240 as appropriate, reproduces the contents data acquired with the reproducing section 252 and outputs the contents through the output device 300. The access state recognizing unit 295 of the CPU 290, upon recognition of beginning of access processing with the access controlling unit 294, acquires a current time information from the timer 297 and recognizes a start time of the access processing.

The user thereafter sets and inputs access termination information requesting termination of contents reproduction with input operations on the input unit 260 as appropriate. The access controlling unit 294 of the CPU 290, upon acquiring the access termination information, terminates the access processing (Step S404). Here, the access controlling unit 294 terminates the reproduction of the contents. The access state recognizing unit 295, upon recognition of termination of access processing with the access controlling unit 294, acquires a current time information from the timer 297 and recognizes an finish time of the access processing.

Thereafter, the access state recognizing unit 295 judges whether the access duration is equal to or longer than the changing reference duration R or not, based on the beginning time and termination time of the access processing (Step S405). In the Step S405, when the access state recognizing unit 295 of the CPU 290 judges that the access duration is shorter than the changing reference duration R, the access state recognizing unit 295 terminates the access processing. When, on the other hand, the access state recognizing unit 295 of the CPU 290 judges in the Step 405 that the access duration is equal to or longer than the changing reference duration R, the access state recognizing unit 295 identifies the number specifying the contents having been accessed based on the contents specifying information acquired with the access controlling unit 294. The access state recognizing unit 295 further searches for contents management information 610 with a contents number 611 carrying the recognized contents number from the contents management list information 600. The access state recognizing unit 295 then increments the access number information 616 of the contents management information 610 by 1 (Step S406). Thereafter the access state recognizing unit 295 judges whether the access flag 615 of the contents management information 610 is set to “0” or not (Step S407).

In the Step S407, when the access state recognizing unit 295 of the CPU 290 judges that the access flag 615 is set to “1” and not to “0”, the access state recognizing unit 295 terminates the access processing. When, on the other hand, the access state recognizing unit 295 judges that the access flag 615 is set to “0” in the Step 407, the access state recognizing unit 295 sets the access flag 615 to “1” (Step S408). The CPU 290 thereafter terminates the access processing to the contents.

(Contents Management Processing)

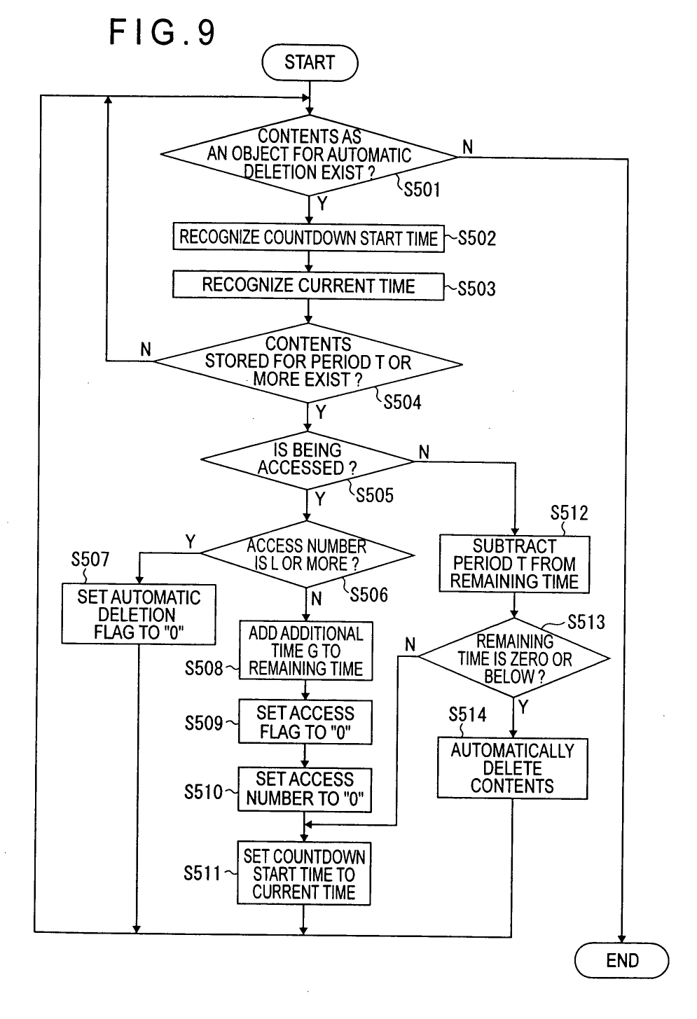

Contents management processing as a function of the contents recording/reproducing system 100 is next described with reference to FIG. 9.

The recording/reproducing device 200 first confirms with the contents management unit 296 of the CPU 290 whether each set of contents is subject to automatic deletion or not based on the automatic deletion flag 612 of each of the contents management information 610 included in the contents management list information 600 (Step S501). If in the Step S501, the contents management unit 296 judges that no sets of contents is subject to automatic deletion, the contents management unit 296 terminates the contents management processing. When, on the other hand, the contents management unit 296 judges in the Step S501 that there are contents subject to automatic deletion, the contents management unit 296 recognizes a countdown start time based on the countdown start information 614 of the contents management information 610 corresponding to the contents (Step S502). Here, when contents management unit 296 recognizes that a plurality of sets of contents is subject to automatic deletion, the contents management unit 296 identifies a countdown start time of each of the contents. Thereafter the contents management unit 296 acquires current time information from the timer 297 and recognizes a current time (Step S503). The contents management unit 296 then judges whether there are contents with a period from the countdown start time equal to or longer than the period T or not. (Step S504).

In the Step S504, when the contents management unit 296 judges that there are no contents with a period from the countdown start time equal to or longer than the period T, the contents management unit 296 performs the processes in the Step S501, for instance, after a prespecified time has elapsed. On the other hand, when the contents management unit 296 judges in the Step S501 that there are contents with a period from the countdown start time equal to or longer than the period T, the contents management unit 296 identifies the contents management information 610 corresponding to the contents. Thereafter, the contents management unit 296 judges whether the access processing to the contents has been performed or not based on the access flag 615 of the contents management information 610 (Step S505). If in the Step S505, the contents management unit 296 judges that the access processing to the contents has been performed, the contents management unit 296 judges whether the access number is less than the cutoff count L or not based on the access number information 616 of the contents management information 610 (Step S506). If in the Step S506, the contents management unit 296 judges that the access number is equal to or larger than the cutoff count L, the contents management unit 296 sets the automatic deletion flag 612 of the contents management information 610 to “0” (Step S507). Thereafter, the contents management unit 296 performs, for instance, the processes in the Step S501 after the prespecified time has elapsed.

On the other hand, when the contents management unit 296 judges in the Step S506 that the access number is less than the cutoff count L, the contents management unit 296 incorporates the additional period G to the remaining time as indicated by the remaining time information 613 of the contents management information 610 (Step S508). The contents management unit 296 also sets the access flag 615 of the contents management information 610 to “0” (Step S509), and sets the access number as indicated by the access number information 616 to 0 (Step S510). Further, contents management unit 296 sets the countdown start time indicated by the countdown start information 614 of the contents management information 610 to the current time (Step S511). Thereafter the contents management unit 296 performs, for instance, the processes in the Step S501 after the prespecified time has elapsed.

On the other hand, when the contents management unit 296 judges that the access processing to the contents has not been performed, the contents management unit 296 subtracts the period T from the remaining time as indicated by the remaining time information 613 (Step S512) and judges whether the remaining time exceeds 0 or not (Step S513). If in the Step S513 the contents management unit 296 judges that the remaining time is less than 0, the contents management unit 296 performs the processes in the Step S511. When, on the other hand, the contents management unit 296 judges that the remaining time is 0 or less, the contents management unit 296 automatically deletes the contents from the HDD 270 (Step S514), and deletes the contents management information 610 corresponding to the contents from the contents management list information 600. The contents management unit 296 then performs, for instance, the processes in the Step S501 after the prespecified time has elapsed.

[Effect of the Contents Recording/Reproducing System]

As described above, the CPU 290 of the recording/reproducing device 200 according to the embodiment above, upon recognition that the current time matches the video recording start time included in the basic video recording information 521 of the reservation information 520, starts, with the video recording control unit 292, the video recording process of the reserved contents with the reservation information 520 to the HDD 270. Thereafter, upon recognition that the current time matches the video recording finish time included in the basic video recording information 521, the CPU 290 terminates the recording process of the contents. The CPU 290, with the management information generating unit 293, sets the remaining time until the automatic deletion of the contents from the HDD 270 to a prespecified time Z, and generates the remaining time information 613 coding the remaining time. The CPU 290 further sets the countdown start time to the video recording finish time and generates the countdown start information 614 concerning the countdown start time. The CPU 290 then generates the contents management information 610 including the remaining time information 613, the countdown start information 614 and others. Thereafter, the CPU 290, upon recognition with the contents management unit 296 that the elapsed time from the countdown start time is equal to or longer than the period T, the CPU 290 judges whether the access processing to the contents with the access controlling unit 294 has been performed or not. When the CPU judges that the access processing has been performed, the CPU 290 incorporates the additional period G to the remaining time as indicated by the remaining time information 613 and sets the time of performing the remaining time alteration process to the countdown start time as indicated by the countdown start information 614. When, on the other hand, the CPU judges that the access processing has not been performed, the CPU subtracts the period T from the remaining time as indicated by the remaining time information 613 and sets the time of performing the remaining time alteration process to the countdown start time as indicated by the countdown start information 614. Thereafter the contents management unit 296 performs the processes described above every time the period T has elapsed from the countdown start time, and upon recognition that the remaining time of contents is 0 or less, the contents management unit 296 automatically deletes the contents from the HDD 270.

As a result, the recording/reproducing device 200 can set the period to the automatic deletion longer for reproduced contents than unreproduced contents. Hence, the user can prolong the period to automatic deletion of the contents by simply setting and inputting the contents reproduction request of favorite contents and does not have to perform a specific setting and inputting designed to prolong the period. Also, the period to automatic deletion of the reproduced contents is set longer than the period for unreproduced contents, and therefore the configuration prevents unexpected automatic deletion of the user's favorite contents better than the conventional configuration. Therefore, the recording/reproducing device 200 erases contents as appropriately. Further, unreproduced contents, which are not the user's favorite, are automatically deleted prior to reproduced contents, which are the user's favorite, and hence contents that are not the user's favorite are not stored on the HDD 270 for a prolonged period. Therefore, the recording/reproducing device 200 can secure free space on the HDD 270 appropriately, and can minimize the risk of being unable to store contents of the user's favorite due to, for instance, a shortage of free space. The number of contents stored on the HDD 270 can also be optimized, and the processing load of, for instance, the access controlling unit 294 performing specific processing of contents at the time of the access processing can be reduced.

The contents management unit 296 performs a process of adding the additional period G to the remaining time as indicated by the remaining time information 613 at the time of prolonging the period until automatic deletion. Therefore, the contents management unit 296 can prolong the period until automatic deletion with a simple method of adding the additional period G to the remaining time. Hence, the processing load of prolonging the period until deletion can be reduced.

The access state recognizing unit 295 recognizes the access duration to the contents controlled by the access controlling unit 294. When the access state recognizing unit 295 recognizes that the access duration is equal to or longer than the changing reference duration R, the access state recognizing unit 295 recognizes that the access processing has been performed. The contents management unit 296 sets the period until automatic deletion of the contents longer upon recognition of the access processing performed on the contents. Therefore, the recording/reproducing device 200 does not prolong the period until automatic deletion when the user, for instance, erroneously reproduces contents, which are not the user's favorite, and the reproduction duration is not over the changing reference duration R. Therefore, the recording/reproducing device 200 does not prolong the period until automatic deletion of contents, which are not the user's favorite, against the user's will, hence improving the user-friendliness of the recording/reproducing device 200.

The access state recognizing unit 295 sets “1” to the access flag 615 of the contents management information 610 upon recognition of the access process performed. The contents management unit 296 judges whether the access processing has been performed or not based on the access flag 615. Therefore the contents management unit 296 can judge whether the access processing is performed or not with a simple method of recognizing the setting of the access flag 615, and can speed up the contents management processing.

The access state recognizing unit 295 recognizes the access number to the contents during the period T. When the contents management unit 296 judges that the access number as recognized by the access state recognizing unit 295 is equal to or larger than the cutoff count L, the contents management unit 296 sets the contents as not subject to automatic deletion. Therefore, the user can prevent unexpected automatic deletion of the contents by reproducing the contents of the user's favorite more than L times during the period T and does not have to perform specific setting and inputting. Hence the user-friendliness of the recording/reproducing device 200 can be improved.

The video recording reservation setting unit 291 of the CPU 290, upon recognition of keywords of the automatic video recording reservation request information set and inputted by the user, acquires the EPG data stored on the HDD 270 before hand. Further, the video recording reservation setting unit 291 searches for contents that matches or relates to the keyword based on the EPG data and generates the reservation information 520 for automatically reserved video recording of the searched contents. Thereafter, the video recording control unit 292 performs automatically reserved video recording of the contents based on the reservation information 520. At the same time, the management information generating unit 293 sets the remaining time until automatic deletion of the contents video-recorded with automatic reservation and generates the contents management information 610 including the remaining time information 613 and others. The contents management unit 296 automatically deletes contents as appropriate based on information such as whether access processing has been performed or not. Therefore, when the recording/reproducing device 200 performs automatically reserved video recording of contents matching, for instance, the keyword but not to the user's taste, the recording/reproducing device 200 can automatically delete the contents from the HDD 270 without the user having to perform setting and inputting request for deleting the contents. Hence, the recording/reproducing device 200 can secure free space on the HDD 270 appropriately, and the user-friendliness of the recording/reproducing device 200 can be enhanced further.

The video recording reservation setting unit 291 recognizes various information including the video recording start time, the video recording finish time and the channel number on the manual video recording reservation request information set and inputted by the user. The video recording reservation setting unit 291 then generates reservation information 520 for manually making video recording reservation of the contents specified by the various information. Thereafter, the video recording control unit 292 performs a manually reserved video recording of the contents based on the reservation information 520. At the same time, the management information generating unit 293 generates the contents management information 610 without setting the remaining time until automatic deletion of the contents manually video-recorded. The contents management unit 296 does not subject the contents video-recorded with manual reservation to automatic deletion and only deletes contents video-recorded with automatic reservation as appropriate. Therefore, the recording/reproducing device 200 does not automatically delete contents when the user identifies the user's favorites and performs manually reserved video recording of contents. Hence, the recording/reproducing device 200 fully prevents automatic deletion of contents video-recorded with manual reservation with the user's specification, while the recording/reproducing device 200 can automatically delete contents video-recorded with automatic reservation but not, for example, to the user's taste, as described above. The user-friendliness of the recording/reproducing device 200 can thus be enhanced further.

The management information generating unit 293 sets “0” to the automatic deletion flag 612 of the contents management information 610 related to contents video-recorded with manual reservation and sets “1” to the automatic deletion flag 612 related to contents video-recorded with automatic reservation. The contents management unit 296 judges whether the contents associated with the contents management information 610 are video-recorded with automatic reservation or not, that is, whether the contents is subject to automatic deletion or not, based on the setting of the automatic deletion flag 612. The contents management unit 296 can therefore judge whether contents subject to automatic deletion are stored on the HDD or not with a simple method of recognizing the setting of the automatic deletion flag 612. Hence, the contents management unit 296 can speed up the contents management processing.

[Variations to the Embodiment]

The present invention is not limited to the embodiment described above by way of example only, but encompasses variations within the scope and intent of the present invention, including variations described hereinafter.

For instance, such a configuration is possible in which the management information generating unit 293, upon recognition of contents having been stored, nay set a contents deletion time as a data deletion time of automatic deletion of contents to a time, which is a prespecified time Z after the video recording finish time. The contents management unit 296 sets the data deletion time until a time later than the original data deletion time based on the status of access processing, as well as automatically deletes the contents upon recognition that the current time is past the data deletion time.

In the configuration above, when the contents management unit 296 judges in the Step S505 that access processes to the contents have not been performed, the contents management unit 296 judges whether the current time is past the data deletion time or not. When the contents management unit 296 judges that the current time is past the data deletion time, the contents management unit 296 performs processes in the Step 514; when the contents management unit 296 judges that the current time is not past the data deletion time, the contents management unit 296 performs processes in the Step 515. Namely, the contents management unit 296 performs just one process of judging whether the current time is past the data deletion time between the Step S505 and the Step S514. Therefore, compared to the configuration according to the embodiment in which two processes, the Step S512 and the Step S513, are performed, the number of step S is reduced. Hence, the recording/reproducing device 200 according to the variation of the embodiment can speed up the contents management processing compared to the recording/reproducing device 200 according to the embodiment. The processing load of the contents management unit 296 can also be reduced.

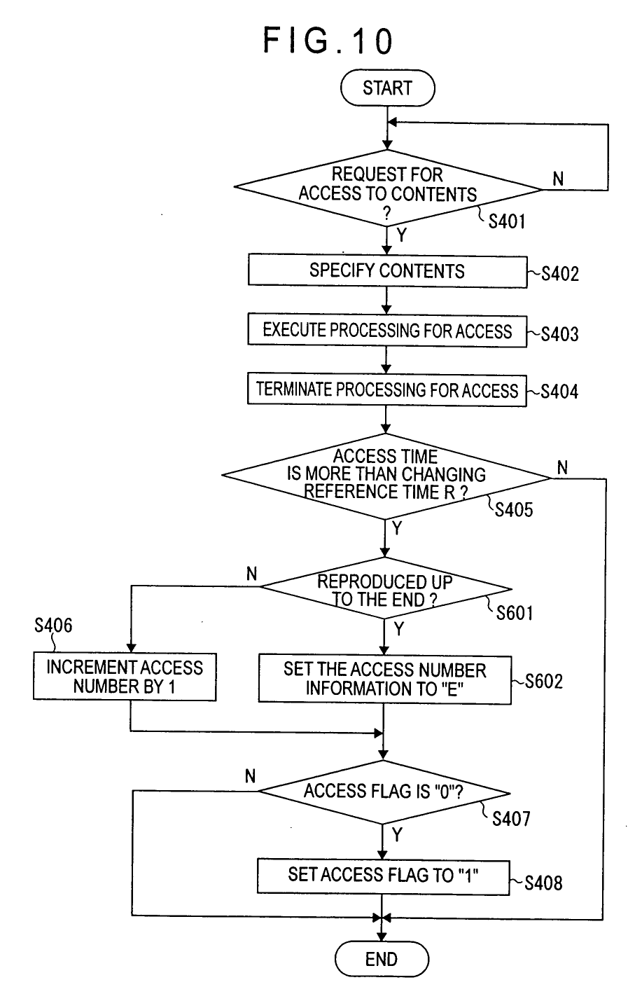

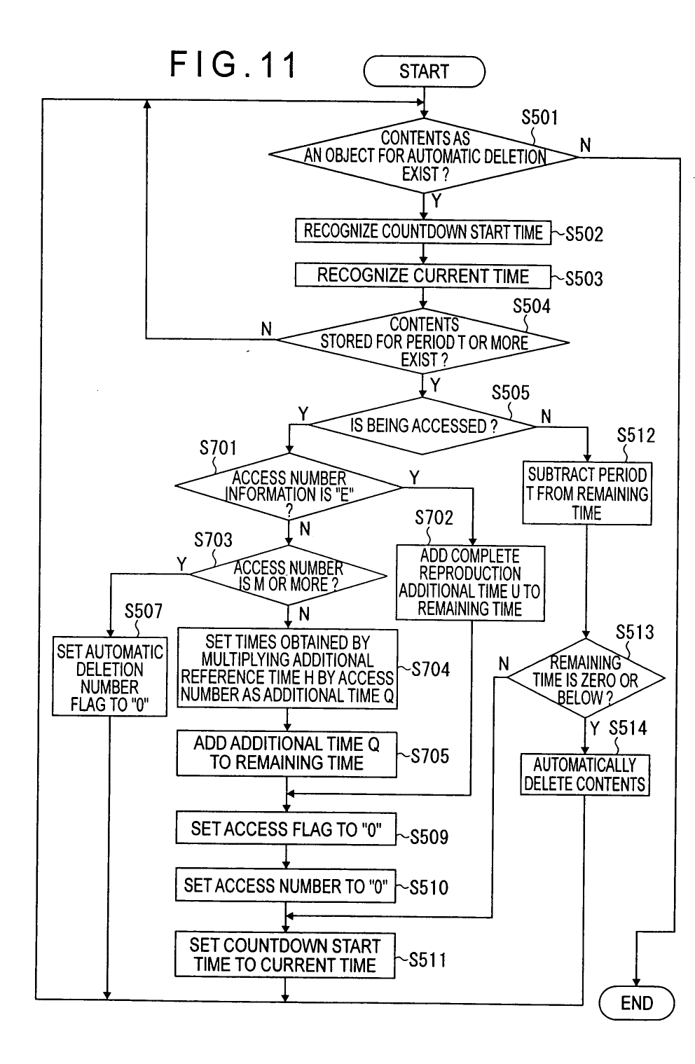

Another configuration is possible in which, for instance, the access state recognizing unit 295 is configured so that, upon recognition that contents data have been reproduced from about the start to about the end of the contents data under control of the access controlling unit 294, that is, the contents have been reproduced from the beginning to the end, the access state recognizing unit 295 sets ‘E’ to the access number of the access number information 616. Further, the contents management unit 296 is configured so that the contents management unit 296 automatically deletes contents as appropriate based on whether the contents have been reproduced to the end or not, as well as on the access number. The contents access processing may be configured as shown in FIG. 10, and the contents management processing may be configured as shown in FIG. 11, according to the configuration. The configuration is referred to hereinafter as the configuration of variation example.

In the configuration of variation example, the access state recognizing unit 295, as shown in FIG. 10, upon recognition in the Step S405 that the access duration to the contents is equal to or longer than the changing reference duration R, judges whether the contents have been produced from the beginning to the end or not (Step S601). In the Step S601, such judging methods may be given, by way of example only, as a method of judging whether the contents have been reproduced from the beginning to the end in one reproduction processing or not, or of judging whether the contents have been reproduced from the beginning to the end in a plurality of reproduction processing or not, each performed at an arbitrary interval. In the Step S601, when the access state recognizing unit 295 judges that the contents have not been reproduced to the end, the access state recognizing unit 295 performs processes in the Step S406. When, on the other hand, the access state recognizing unit 295 judges in the Step S601 that the contents have been reproduced to the end, the access state recognizing unit 295 sets ‘E’ to the access number of the access number information 616 (Step S602) and performs processes in the Step S407.

The contents management unit 296, upon recognition that the access processing to the contents subject to automatic deletion has been performed in Step S505, judges whether the access number is set to ‘E’ or not based on the access number information 616 (Step S701) as shown in FIG. 11. In the Step S701, when the contents management unit 296 judges that the access number is set to ‘E’, the contents management unit 296 incorporates a prespecified complete reproduction additional time U to the remaining time as indicated by the remaining time information 613 (Step S702). The complete reproduction additional time U is set to a time shorter than the period T or an additional reference time H as described later, or set to 0. Thereafter, the contents management unit 296 performs processes in the Step S509. When, on the other hand, the contents management unit 296 judges in the Step S701 that the access number is not set to ‘E’, the contents management unit 296 performs processes similar to those in the Step S506 and judges whether the access number is than a prespecified cutoff count M (M is a natural number) or not (Step S703). In the Step S703, when the contents management unit 296 judges that the access number is equal to or more than the cutoff count M, the contents management unit 296 performs processes in Step S507. When, on the other hand, the contents management unit 296 judges in the Step S703 that the access number is less than the cutoff count M, the contents management unit 296 sets an additional time Q to a prespecified additional reference time H multiplied by the access number (Step S704). It is also possible to configure so that the additional time Q is set to the period T, not the additional reference time H, multiplied by the access number. Thereafter, the contents management unit 296 incorporates the additional time Q to the remaining time as indicated by the remaining time information 613 (Step S705) and performs processes in the Step S509.

The recording/reproducing device 200 according to the configuration of variation example can set the additional time Q to be added to the remaining time as indicated by the remaining time information 613 to a time, which is a product of the additional reference time H and the access number during the period T. Namely, the recording/reproducing device 200 sets the period until automatic deletion of contents in accordance to the access number during the period T. Hence, when the user reproduces contents, which are particularly to the user's taste, for a plurality of times, for instance, the recording/reproducing device 200 can set the period until automatic deletion of the contents longer than for contents not very much to the user's taste and have been reproduced just once. Therefore, the recording/reproducing device 200 can set the period until automatic deletion of contents in accordance to the access number, corresponding to, for instance, the user's taste. Hence, the recording/reproducing device 200 can delete contents even more appropriately.

The access state recognizing unit 295, upon recognition that contents have been reproduced from the beginning to the end, sets the access number of the access number information 616 to ‘E’. The contents management unit 296, upon recognition that contents have been reproduced from the beginning to the end based on the access number information 616, incorporates the complete reproduction additional time U, set to be a time shorter than the additional reference time H, to the remaining time until the automatic deletion of the contents. The recording/reproducing device 200, therefore, can set the period until automatic deletion of contents reproduced from the beginning to the end and less likely to cause problems when deleted automatically shorter than the period until automatic deletion of contents not reproduced from the beginning to the end and more likely to cause problems when deleted automatically. Hence, the recording/reproducing device 200 can set the period until automatic deletion in accordance to the impact of automatic deletion of the contents, and can therefore delete contents even more appropriately.

In the configuration of variation example, a configuration is described above by way of example only in which the additional time Q to be added to the remaining time is set to a product of the additional reference time H and the access number, but another configuration is also possible, in which the additional time Q is set to a constant time regardless of the access number. In such a configuration, the contents management unit 296, upon recognition in the Step S703 that the access number is equal to or more than the cutoff count M, performs processes similar to those in the Step S705 and incorporates the additional time Q, which is a constant time, to the remaining time. Therefore, the processes in the Step S704 can be omitted, and the contents management unit 296 can speed up the content management processing. The configuration is also simpler as the contents management unit 296 does not need to be equipped with a functionality to calculate the additional time Q, resulting in a simpler configuration, and the cost of the recording/reproducing device 200 can be reduced. Further, the processing load of the contents management unit 296 can be reduced.

In the configuration of variation example, a configuration is described above by way of example only in which the contents management unit 296, upon recognition that contents have been reproduced from the beginning to the end, incorporates the complete reproduction additional time U to the remaining time, but another configuration is also possible, in which such a process is omitted. In such a configuration, the access state recognizing unit 295 performs the access process to the contents as shown in FIG. 8 of the embodiment. The contents management unit 296, upon recognition that the access process to the contents subject to automatic deletion has been performed in Step S505, performs processes in the Step S703. Therefore, the processes in the Step S S601 and S602 can be omitted, and the access processing to the contents can be sped up. The processes in the Step S S701 and S702 can also be omitted, and the access processing to the contents can be sped up. Further, the access state recognizing unit 295 does not need to be equipped with a functionality to judge whether contents have been reproduced from the beginning to the end or not, and the contents management unit 296 does not need to be equipped with a functionality to judge whether the access number information 616 is set to ‘E’ or not, the configurations of the access state recognizing unit 295 and the contents management unit 296 can be simplified, and the cost of the recording/reproducing device 200 can be reduced. Further, the processing loads of the access state recognizing unit 295 and the contents management unit 296 can be reduced.

In the configuration of variation example, a configuration is possible, for instance, in which the contents management unit 296, upon recognition that contents subject to automatic deletion have been reproduced from the beginning to the end, sets the contents as not subject to automatic deletion. In such a configuration, the user can set the contents as not subject to automatic deletion by just reproducing the user's favorite contents from the beginning to the end, and does not have to perform specific setting and inputting. The user-friendliness of the recording/reproducing device 200 can thus be improved further.

In the configuration of variation example, a configuration is described above by way of example only in which the contents management unit 296 sets the additional reference time H multiplied by the access number to the additional time Q, but another configuration is also possible, in which the contents management unit 296 sets the additional time Q to the additional reference time H multiplied by a number according to the type of access process. Specifically, for instance, the contents management unit 296 sets the additional time Q to the additional reference time H when the access process is for reproduction, and sets the additional time Q to a time, which is a product of the additional reference time H and 2, when the access process is for editing. In such a configuration, the recording/reproducing device 200 sets, for instance, the period until automatic deletion of the user's favorite contents subjected to editing longer than the period until automatic deletion of contents not particularly to the user's taste and not subjected to editing. Therefore, the recording/reproducing device 200 can set the period until automatic deletion of contents according to the type of access process, mirroring, for instance, the user's taste. Hence, the recording/reproducing device 200 can delete contents even more appropriately.

In the configuration of variation example, a configuration is described above by way of example only in which the contents management unit 296 sets the additional reference time H multiplied by the access number to the additional time Q, but another configuration is also possible, in which the contents management unit 296 sets the additional time Q to the additional reference time H multiplied by a number in accordance to the access duration. Specifically, for instance, when the access duration is 30 minutes, the contents management unit 296 sets the additional time Q to the additional reference time H, while when the access duration is an hour, the contents management unit 296 sets the additional time Q to a time which is a product of the additional reference time H and 2. In such a configuration, the recording/reproducing device 200 sets, for instance, the period until automatic deletion of the user's favorite contents reproduced for an hour longer than the period until automatic deletion of contents not particularly to the user's taste and reproduced only for 30 minutes. Therefore, the recording/reproducing device 200 can set the period until automatic deletion of contents according to the reproduction duration, mirroring, for instance, the user's taste. Hence, the recording/reproducing device 200 can delete contents even more appropriately.

In the configuration of variation example, a configuration is described above by way of example only in which the access state recognizing unit 295, upon recognition that the access duration to the contents is equal to or longer than the changing reference duration R, judges that the access processing has been performed, but another configuration is also possible. Namely, the access state recognizing unit 295, upon recognition that the access controlling unit 294 has acquired the reproduction request information or the edit request information, judges that the access processing has been performed regardless of the access duration. In such a configuration, the access processing of contents in the embodiment or in the configuration of variation example above, namely the processes in the Step S405, can be omitted, and the access process to contents can be sped up. The processing load of the access state recognizing unit 295 can also be reduced.

A configuration is described above by way of example only in which the contents management unit 296, upon recognition that the access number to the contents subject to automatic deletion is equal to or more than the count L, sets the contents as not subject to automatic deletion, but another configuration is also possible without the functionality. In such a configuration, the contents management unit 296, upon recognition in the Step S506 that the access number to the contents is equal to or more than the count L, performs processes in the Step S501. Therefore, the processes in the Step S507 can be omitted, and the contents management process can be sped up. The contents management unit 296 does not have to be equipped with a functionality to set contents as not subject to automatic deletion, the configuration can therefore be simplified, and the cost of the recording/reproducing device 200 can be reduced. Further, the processing load of the contents management unit 296 can be reduced.

Another configuration is possible in which the contents management unit 296, upon recognition that the access process to contents subject to automatic deletion is one of prespecified types, sets the contents as not subject to automatic deletion. Specifically, when the access process is, for instance, for editing, the contents management unit 296 sets the contents as not subject to automatic deletion. In such a configuration, the user can set the contents as not subject to automatic deletion by just editing the user's favorite contents, and does not have to perform specific setting and inputting. The user-friendliness of the recording/reproducing device 200 can thus be improved further.

Another configuration is possible in which the contents management unit 296, upon recognition that the access duration to contents subject to automatic deletion is equal to or longer than a prespecified non-automatic deletion threshold time, sets the contents as not subject to automatic deletion. In such a configuration, the user can set the contents as not subject to automatic deletion by just reproducing the user's favorite contents for a period equal to or longer than the non-automatic deletion threshold time, and does not have to perform specific setting and inputting. The user-friendliness of the recording/reproducing device 200 can thus be improved further.

Another configuration is possible in which the contents management unit 296, upon recognition that the remaining time as indicated by the remaining time information 613 is equal to or longer than a prespecified threshold time K, sets the contents corresponding to the contents management information 610 including the remaining time information 613 as not subject to automatic deletion. In such a configuration, the user can set the contents as not subject to automatic deletion by just increasing the access number to the user's favorite contents, and does not have to perform specific setting and inputting. The user-friendliness of the recording/reproducing device 200 can thus be improved further.

In another possible configuration, the output device 300 may be configured to function as an annunciation unit. The access controlling unit 294 may be configured to function as an annunciation controlling unit and, upon performing the access process to contents, outputs the remaining time to the output device 300 based on the remaining time information 613. Further, the access controlling unit 294 may be configured so that, based on the user's setting and inputting, the access controlling unit 294 outputs the remaining time of each of the contents subject to automatic deletion to the output device 300. In such a configuration, the recording/reproducing device 200 can easily make the user aware of the remaining time until automatic deletion of contents, which the user is accessing. The user-friendliness of the recording/reproducing device 200 can thus be improved further.

A configuration is described above by way of example only in which contents video-recorded with manual reservation are not set to be subject to automatic deletion, but another configuration is possible in which the contents video-recorded with manual reservation are set to be subject to automatic deletion. In such a configuration, the recording/reproducing device 200 can automatically delete contents video-recorded with manual reservation as appropriate based on the access processing state. The user-friendliness of the recording/reproducing device 200 can thus be improved further.

A configuration is described above by way of example only in which the processing controller and the data processor according to the present invention are applied to the recording/reproducing device 200 storing contents data, but the scope is not limited to the above description. For instance, the present invention may be applied to, in addition to TV broadcasting programs, such data as radio broadcasting programs, satellite broadcasting programs and various data distributed via network such as music data, video data, application software, game software and various controlling programs. A configuration is described above in which the present invention is applied to the recording/reproducing device 200, but the present invention may also be applied to a recorder that only stores data, or to an independent processing controller deleting, as appropriate, data stored on the recorder or the recording/reproducing device 200.

A configuration is described above by way of example only in which each of the functionalities is built as a software program, but other configurations are possible in which the functionalities are built as hardware such as, for instance, a circuit board, or as an element device such as a single IC (Integrated Circuit), and any form can be adopted. By building the present invention as programs, or programs readable from recording media provided separately, the present invention can be made easy to handle and easy to expand the potential applications.

The tangible structures and procedures according to the present invention may be modified to other structures and procedures within the scope and intent of the present invention.

[Effect of the Embodiment]

As described above, the CPU 290 of the recording/reproducing device 200 according to the embodiment above starts video recording processing of the contents reserved with the reservation information 520 to the HDD 270 with the video recording control unit 292. Upon terminating the video recording processing, the CPU 290 sets the remaining time until automatic deletion of the contents from the HDD 270 to the prespecified time Z with the management information generating unit 293, and generates remaining time information 613 including the remaining time. Further, the CPU 290 sets the countdown start time to the video recording finish time, and generates countdown start information 614 concerning the countdown start time. Thereafter, the CPU 290, upon recognition that the elapsed time from the countdown start time is equal to or longer than the period T with the contents management unit 296, judges whether the access processing to the contents have been performed or not with the access controlling unit 294. When the CPU 290 judges that the access processing to the contents has been performed, the CPU 290 incorporates the additional time G to the remaining time as indicated by the remaining time information 613 and sets the countdown start time of the countdown start information 614 to the time the alteration process is performed. When, on the other hand, the CPU 290 judges that the access processing to the contents has not been performed, the CPU 290 subtracts the period T from the remaining time as indicated by the remaining time information 613 and sets the countdown start time of the countdown start information 614 to the time the alteration process is performed. Thereafter, the contents management unit 296 repeats the processes described above every time the period T has elapsed from the countdown start time, and upon recognition that the remaining time is 0 or less, deletes the contents from the HDD 270.

Therefore, the recording/reproducing device 200 can, for instance, set the period until automatic deletion of reproduced contents longer than the period until automatic deletion of not-reproduced contents. Hence, the user can prolong the period until automatic deletion of contents by performing setting and inputting reproduction request, compared to the period until automatic deletion prior to requesting reproduction, and does not have to perform specific setting and inputting for prolonging the period until automatic deletion. Further, the period until automatic deletion of reproduced contents is set longer than the period until automatic deletion of not-reproduced contents, and unexpected automatic deletion of the user's favorite contents can be prevented better than in the conventional configuration. The recording/reproducing device 200 can hence delete contents as appropriate.

The priority application Number JP2004-164934 upon which this patent application is based is hereby incorporated as reference.

1. A processing controller controlling a data deleting unit, which is adapted for deleting data stored in a storage unit, to delete the data, comprising:
a storage time acquiring unit for acquiring data storage time information concerning time at which the data was stored in said storage unit;
a storage period acquiring unit for acquiring data storage period information concerning a period in which said data is stored in said storage unit;
a processing state recognizing unit for recognizing, with a processing executing unit for executing processing of said data, the processing state of said data;
a storage period changing unit for prolonging the period indicated by said data storage period information based on the processing state; and
a deletion controlling unit for acquiring current time information concerning the current time and controlling said data deleting unit to delete, when recognizing that the elapsed time from the time indicated by said data storage time information exceeds the period indicated by said data storage period information, said data corresponding to the data storage time information.

2. The processing controller according to claim 1,
wherein said storage period changing unit adds, based on said processing state, a prespecified period of time to a period of time indicated by said data storage period information.

3. The processing controller according to claim 1,
said storage period acquiring unit acquires data deletion time information concerning time at which said data deleting unit deletes said data as said data storage period information;
said storage period changing unit sets the time indicated by data deletion time information to a later time based on the processing state; and
said deletion controlling unit controls said data deleting unit to delete, when recognizing that the current time indicated by said acquired current time information exceeds the time specified by said data deleting unit, said data.

4. The processing controller according to claim 1,
wherein said storage period changing unit sets the period indicated by said data storage period information to be long according to times of processing of said data.

5. The processing controller according to claim 1,
wherein said storage period changing unit sets the period indicated by said data storage period information to be long according to contents of processing of said data.

6. The processing controller according to claim 1,
wherein said storage period changing unit sets the period indicated by said data storage period information to be long when recognizing that the processing time for data exceeds a prespecified reference time for changing.

7. The processing controller according to claim 1,
wherein said storage period changing unit sets the period indicated by said data storage period information to be long according to processing time of said data.

8. The processing controller according to claim 1 further comprising:
an annunciation controlling unit for making an annunciating unit annunciate the period indicated by said data storage period information.

9. The processing controller according to claim 1,
wherein said data has a data string structure; and
said storage period changing unit sets, when recognizing that the general data processing for processing the data from the head portion to the end portion of the data string structure was carried out, the period indicated by said data storage period information to be shorter than that set when it is recognized that the processing other than the general data processing was carried out.

10. The processing controller according to claim 1,
wherein said data has a data string structure, and
said date deleting unit controls, when recognizing that the processing of the data from the head portion to the end portion of said data string structure was carried out, said data deleting unit to not delete said data.

11. The processing controller according to claim 1,
wherein said deletion controlling unit controls, when recognizing that times of processing of said data is not less than prespecified number, said data deleting unit to not delete said data.

12. The processing controller according to claim 1,
wherein said deletion controlling unit controls, when recognizing that the processing for said data is a prespecified one, said data deleting unit to not delete said data.

13. The processing controller according to claim 1,
wherein said deletion controlling unit controls, when recognizing that the processing time for said data is not less than a prespecified non-deletion reference time, said data deleting unit to not delete said data.

14. A data processor comprising:
a data storage unit for storing data;
a data storage controlling unit for acquiring and storing data in said storage unit;
a data deleting unit for deleting data stored in said storage unit;
a processing controller for controlling said data deleting unit, which is adapted for deleting data stored in a storage unit, to delete said data;
a processing executing unit for executing processing for said data; and
a timer for clocking the current time,
wherein said processing controller comprises:
a storage time acquiring unit for acquiring data storage time information concerning time at which the data was stored in said storage unit;
a storage period acquiring unit for acquiring data storage period information concerning a period in which said data is stored in said storage unit;
a processing state recognizing unit for recognizing, with a processing executing unit for executing processing of said data, the processing state of said data;
a storage period changing unit for prolonging the period indicated by said data storage period information based on the processing state; and
a deletion controlling unit for acquiring current time information concerning the current time and controlling said data deleting unit to delete, when recognizing that the elapsed time from the time indicated by said data storage time information exceeds the period indicated by said data storage period information, said data corresponding to the data storage time information.

15. The data processor according to claim 14 comprising:
a character information acquiring unit for acquiring character information; and
a data-related information acquiring unit for acquiring data-related information including character information related to a plurality of said data respectively;
wherein said data storage controlling unit retrieves character information relating to the character information acquired by said character information acquiring unit from said data-related information, acquires said data relating to the retrieved character information and stores the acquired data in said storage unit.

16. The data processor according to claim 14 comprising:
a storage request information acquiring unit for acquiring specified data storage request information which requests the specified data be stored in said storage unit,
wherein said data storage controlling unit acquires said specified data and stored the acquired data in said storage unit, based on said specified data storage request information.

17. The data processor according to claim 16,
wherein said deletion controlling unit controls said data deleting unit to not delete said specified data stored in said storage unit.

18. The data processor according to claim 17,
wherein said data storage controlling unit correlates, when storing said data in said storage unit, data attribute information, which indicates whether the data is said specified data or not, to said data and stores the data; and
said deletion controlling unit recognizes that the said data stored in said storage unit is said specified data based on said data attribute information.

19. A processing controlling method for controlling, with a computing unit, a data deleting unit adapted for deleting data stored in a storage unit to delete said data, wherein said computing unit executes the steps of:
acquiring data storage time information concerning time at which said data was stored in said storage unit;
acquiring data storage period information concerning a period in which said data is stored in said storage unit;
recognizing, with a processing executing unit for executing processing of said data, the processing state of said data;
prolonging the period indicated by said data storage period information based on the processing state; and
acquiring current time information concerning current time and controlling said data deleting unit to delete, when recognizing that the elapsed time from the time indicated by said data storage time information exceeds the period indicated by said data storage period information, said data corresponding to the data storage time information.

20. A processing controlling program which makes a computing unit, for the purpose of controlling a data deleting unit adapted for deleting data stored in a storage unit to delete said data, function as a processing controller, the processing controller comprising:
a storage time acquiring unit for acquiring data storage time information concerning time at which the data was stored in said storage unit;
a storage period acquiring unit for acquiring data storage period information concerning a period in which said data is stored in said storage unit;
a processing state recognizing unit for recognizing, with a processing executing unit for executing processing of said data, the processing state of said data;
a storage period changing unit for prolonging the period indicated by said data storage period information based on the processing state; and
a deletion controlling unit for acquiring current time information concerning the current time and controlling said data deleting unit to delete, when recognizing that the elapsed time from the time indicated by said data storage time information exceeds the period indicated by said data storage period information, said data corresponding to the data storage time information.

21. A processing controlling program which makes a computing unit, for the purpose of controlling a data deleting unit adapted for deleting data stored in a storage unit to delete said data, execute a processing controlling method, said processing control method comprising the steps of:
acquiring data storage time information concerning time at which said data was stored in said storage unit;
acquiring data storage period information concerning a period in which said data is stored in said storage unit;
recognizing, with a processing executing unit for executing processing of said data, the processing state of said data;
prolonging the period indicated by said data storage period information based on the processing state; and
acquiring current time information concerning current time and controlling said data deleting unit to delete, when recognizing that the elapsed time from the time indicated by said data storage time information exceeds the period indicated by said data storage period information, said data corresponding to the data storage time information.

22. A recording medium which records a processing controlling program in a manner readable by a computing unit, the processing controlling program making a computing unit, for the purpose of controlling a data deleting unit adapted for deleting data stored in a storage unit to delete said data, function as a processing controller, the processing controller comprising:
a storage time acquiring unit for acquiring data storage time information concerning time at which the data was stored in said storage unit;
a storage period acquiring unit for acquiring data storage period information concerning a period in which said data is stored in said storage unit;
a processing state recognizing unit for recognizing, with a processing executing unit for executing processing of said data, the processing state of said data;
a storage period changing unit for prolonging the period indicated by said data storage period information based on the processing state; and
a deletion controlling unit for acquiring current time information concerning the current time and controlling said data deleting unit to delete, when recognizing that the elapsed time from the time indicated by said data storage time information exceeds the period indicated by said data storage period information, said data corresponding to the data storage time information.

23. A recording medium which records a processing controlling program in a manner readable by a computing unit, the processing controlling program making a computing unit, for the purpose of controlling a data deleting unit adapted for deleting data stored in a storage unit to delete said data, execute a processing controlling method, said processing control method comprising the steps of:
acquiring data storage time information concerning time at which said data was stored in said storage unit;
acquiring data storage period information concerning a period in which said data is stored in said storage unit;
recognizing, with a processing executing unit for executing processing of said data, the processing state of said data;
prolonging the period indicated by said data storage period information based on the processing state; and
acquiring current time information concerning current time and controlling said data deleting unit to delete, when recognizing that the elapsed time from the time indicated by said data storage time information exceeds the period indicated by said data storage period information, said data corresponding to the data storage time information.
